(19) United States
(12) Patent Application Publication
(10) Pub. No.: US 2025/0005493 A1
(43) Pub. Date: Jan. 2, 2025

(54) INFORMATION PROCESSING SYSTEM, METHOD FOR PROCESSING INFORMATION, AND NON-TRANSITORY COMPUTER-READABLE MEDIUM STORING COMPUTER PROGRAM

(71) Applicant: Rakuten Group, Inc., Tokyo (JP)

(72) Inventor: Shinichi TAKEUCHI, Tokyo (JP)

(73) Assignee: Rakuten Group, Inc., Tokyo (JP)

(21) Appl. No.: 18/754,657

(22) Filed: Jun. 26, 2024

(30) Foreign Application Priority Data
Jun. 30, 2023 (JP) 2023-107893

(51) Int. Cl. G06Q 10/0639; G06Q 10/04

(52) U.S. Cl. CPC G06Q 10/0639; G06Q 10/04

(57) ABSTRACT

An information processing system includes a memory storing program codes, and a processor executing processes based on the program codes. The processor executes a categorizing process for categorizing users into segments, and an inferring process for inferring, from attributes of the users, one or more transition attributes that are characteristic to a transitioning user who will transition to another segment as time elapses. The inferring process includes an inputting process for inputting user data including the attributes of the users to a learning model. The calculation result includes a result of a prediction of whether each of the users will become the transitioning user, and importance of each of the attributes in the prediction.

### CROSS-REFERENCE TO RELATED APPLICATIONS

This application is based upon and claims the benefit of priority from prior Japanese Patent Application No. 2023-107893, filed on Jun. 30, 2023, the entire contents of which are incorporated herein by reference.

### BACKGROUND

### 1. Field

The following description relates to an information processing system, a method for processing information, and a non-transitory computer-readable medium storing a computer program.

### 2. Description of Related Art

In the field of marketing, potential users in a market may be classified into groups (segments) based on needs or characteristics. Marketing strategies can be carried out in accordance with the characteristics of the segments to efficiently perform sales-promoting activities such as advertisements. Japanese National Phase Laid-Open Patent Publication No. 2018-536947 discloses an example of a method for transmitting electronic messages including segmented user data.

Each user has a variety of attributes, such as age, gender, education, and income. If an attribute highly correlated to a targeted marketing characteristic can be found, segmentation can be performed in a further optimal manner. For example, present users may be segmented based on the usage frequency and expenditure on a certain service. In such a case, if the expenditure of a user increases, that user will be transitioned to a higher expenditure segment. If common attributes characteristic to users that are likely to transition to another segment can be found, sales-promoting activities can be performed further effectively.

It is an objective of the present disclosure to provide an information processing system, a method for processing information, and a non-transitory computer-readable medium storing a computer program that infer, from attributes of users, one or more attributes having a high correlation with a targeted characteristic.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an information processing system includes one or more memories that store computer program codes, and one or more processors operable to execute processes based on the computer program codes. The one or more processors are operable to execute a categorizing process for categorizing users into segments, and an inferring process for inferring, from attributes of the users, one or more transition attributes that are characteristic to a transitioning user who will transition to another segment as time elapses. The inferring process includes an inputting process for inputting user data including the attributes of the users to a learning model. The learning model outputs a calculation result when the user data is input. The calculation result includes a result of a prediction of whether each of the users will become the transitioning user, and importance of each of the attributes in the prediction.

In another general aspect, a method for processing information is implemented by one or more computers. The method includes categorizing users into segments, and inferring, from attributes of the users, one or more transition attributes that are characteristic to a transitioning user who will transition to another segment as time elapses. The inferring includes predicting whether each of the users will become the transitioning user, and calculating importance of each of the attributes in the prediction.

A further general aspect is a non-transitory computer-readable medium storing a computer program, which when executed by one or more computers, causes performance of operations including categorizing users into segments, and inferring, from attributes of the users, one or more transition attributes that are characteristic to a transitioning user who will transition to another segment as time elapses. The inferring includes predicting whether each of the users will become the transitioning user, and calculating importance of each of the attributes in the prediction.

Other features and aspects will be apparent from the following detailed description, the drawings, and the claims.

### BRIEF DESCRIPTION OF THE DRAWINGS

FIG. 1 is a schematic diagram illustrating one embodiment of an information processing system.

FIG. 2 is an exemplary graph illustrating segments and transition paths.

FIG. 3 is an exemplary graph illustrating the number of months that a certain user belonged to each segment.

FIG. 4 is an exemplary graph illustrating the volume of each segment.

FIG. 5 is graph illustrating segments and transition paths in a further example.

FIG. 6 is an exemplary diagram illustrating the importance of features output as SHAP values.

FIG. 7 is table illustrating transition performance coefficients when transitions occur between segments.

FIG. 8 is a flowchart illustrating one embodiment of a method for processing information.

FIG. 9 is a flowchart illustrating a method for outputting a target group.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

An information processing system, a method for processing information, and a non-transitory computer-readable medium recording a computer program will now be described with reference to the drawings. The present disclosure is not limited to these examples and is intended to include all modifications described by the scope of claims and corresponding to equivalents of the scope of claims.

### Information Processing System

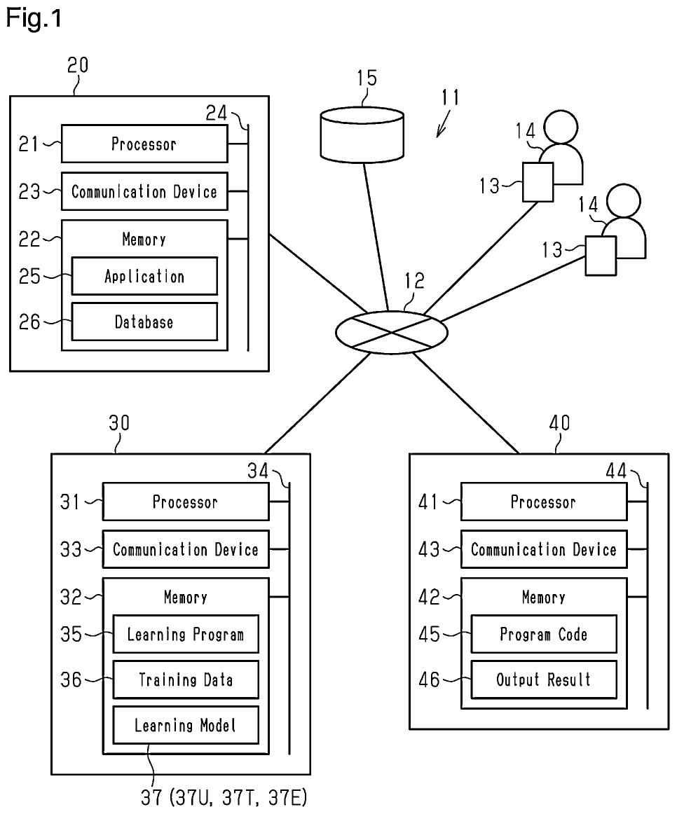

FIG. 1 shows one example of an information processing system 11. The information processing system 11 includes one or more analyzing devices 40. The information processing system 11 may further include one or more service servers 20 and one or more information processing devices 30. In the example described in the present disclosure, the information processing system 11 includes a single analyzing device 40, a single service server 20, and a single information processing device 30. The service server 20, the information processing device 30, and the analyzing device 40 communicate through a network 12 with user terminals 13. The functionalities of the service server 20, the information processing device 30, and the analyzing device 40 may be implemented by one or more servers or devices (e.g., computers). When the service server 20, the information processing device 30, and the analyzing device 40 are all implemented by a single device, for example, a computer, the information processing system 11 is implemented by the single device.

The network 12 includes, for example, the Internet, a Wide Area Network (WAN), a Local Area Network (LAN), a provider terminal, a wireless communication network, a wireless base station, a dedicated line, and the like.

The user terminals 13 may be, but are not limited to, for example, smartphones, personal computers, tablets, or the like. The user terminals 13 are each operated by a user 14. The user 14 uses one or more services provided by a business entity.

The service server 20 includes one or more processors 21, one or more memories 22, a communication device 23, and a communication bus 24 connecting these devices. In the example described in the present disclosure, a single processor 21 executes multiple processes. Nevertheless, any of the one or more processors 21 may execute any one of the processes. Further, in the example described in the present disclosure, data is totally stored in a single memory 22. Data, however, may be distributed and stored in multiple memories 22. The communication device 23 is, for example, an interface for connection to the network 12. The communication device 23 allows for communication through the network 12 with other devices such as the user terminals 13 and the analyzing device 40. The memory 22 stores an application 25 and a database 26 that are used to provide a service.

When the information processing system 11 includes more than one service server 20, the service servers 20 may provide different services. The memory 22 of the service server 20 stores user information in the database 26 for the service provided by the service server 20. The database 26 stores private information and service usage history of the users 14 using a service. When a number of services are provided by the same business entity or by affiliated business entities, the databases 26 that are for different services may be shared.

The analyzing device 40 conducts various analyses that are mainly related to marketing strategies. The analyzing device 40 includes one or more processors 41, one or more memories 42, a communication device 43, and a communication bus 44 connecting these devices. In the example described in the present disclosure, a single processor 41 executes multiple processes. Nevertheless, any of the one or more processors 41 may execute any one of the processes. Further, in the example described in the present disclosure, data is totally stored in a single memory 42. Data, however, may be distributed and stored in multiple memories 42. The communication device 43 is, for example, an interface for connection to the network 12. The communication device 43 allows for communication through the network 12 with other devices such as the service server 20 and the information processing device 30.

The memory 42 may store a computer program code 45 (hereafter, simply referred to as the program code 45), which is used to conduct analyses, and an output result 46. The processor 41 reads the program code 45 from the memory 42 at a predetermined time to execute a process based on the program code 45. More specifically, the processor 41 is operated as instructed by the program code 45 to output various analysis results. Further, the processor 41 may execute a process based on the program code 45 to store the output result 46 in the memory 42. The processor 41 may be operated as instructed by the program code 45 to store the output result 46 in the memory 42.

The information processing system 11 may include one or more analysis databases 15. In the example described in the present disclosure, the information processing system 11 includes a single analysis database 15. The analysis database 15 may be included in an information processing device such as a server device. When the information processing system 11 includes more than one service server 20, the analysis database 15 may store some or all of the user data stored in the database 26 of each service server 20. The user data includes a usage history of one or more services for each user 14 and attribute data of attributes that each user 14 has.

The analysis database 15 may include data generated by processing the data stored in the database 26. The analyzing device 40 and the information processing device 30 exchange data with the analysis database 15 through the network 12. Some or all of the analysis database 15 may be temporarily or permanently stored in the memory 42 of the analyzing device 40 or a memory 32 of the information processing device 30 for various purposes, such as analysis.

Attribute data includes static data items and dynamic data items related to the attributes of the users 14. The term “attribute” as used in this specification refers to information including the combination of an attribute corresponding to a data item (e.g., age) and a value of the attribute (attribute value, e.g., 40). Thus, an attribute may be expressed as, for example, “age: 40.”

Static data items include, but are not limited to, for example, date of birth, place of residence, and date of first purchase (date of service registration). Dynamic data items include name, age, address, family structure, annual income, occupation, hobby, and information related to product or service of interest. The analysis databases 15 may further include a data item related to behavior histories of the users 14. Data items related to behavior histories include, but are not limited to, for example, usage history of a service, purchase history of a product, and browsing or searching history of a website.

The analyzing device 40 is operable to conduct various analyses based on the data included in the analysis database 15 to mainly optimize marketing strategies. The analyses conducted by the analyzing device 40 may include four phases. The four phases are, for example, categorization of the users 14 (first phase), analysis of user attributes (second phase), expansion of target group (third phase), and evaluation of strategic data (fourth phase).

Any of the first to fourth phases may be changed or omitted. For example, the fourth phase may be performed before the first phase. Alternatively, the fourth phase and another phase may be performed simultaneously or alternately while changing analysis conditions. Further, the first to fourth phases may be repeated to optimize a strategy. When repeating the first to fourth phases, some of the phases do not have to be repeated, and the result of any one of the phases may be fed back to other phases. The analysis results may be submitted to a party providing a service for managing the service server 20.

When the information processing system 11 includes more than one analyzing device 40, the analyzing devices 40 may each perform the analysis of a different phase. For example, the information processing system 11 may include first to fourth analyzing devices 40 corresponding to the first to fourth phases, respectively. Analysis results generated by the analyzing device 40, data processed through the analyses, or data generated during the analyses may be stored as part of the analysis database 15. Further, the analyzing device 40 may use the data processed or generated through the analyses in another analysis or in the next analysis.

The information processing devices 30 are each operable to generate a machine learning model 37 (37U, 37T, 37E) to assist analysis. The machine learning model will simply be referred to as learning model. The information processing device 30 includes one or more processors 31, one or more memories 32, a communication device 33, and a communication bus 34. In the example described in the present disclosure, a single processor 31 executes multiple processes. Nevertheless, any of the one or more processors 31 may execute any one of the processes. Further, in the example described in the present disclosure, data is totally stored in a single memory 32. Data, however, may be distributed and stored in multiple memories 32. The communication device 33 is, for example, an interface for connection to the network 12. The communication device 33 allows for communication through the network 12 with other devices such as the analyzing devices 40.

The memory 32 may store one or more learning programs 35, which is for machine learning, and the training data 36. The memory 32 may also store one or more learning models 37 generated with the learning programs 35 and the training data 36. In the example described in the present disclosure, a single learning program 35 and a single learning model 37 are stored in the memory 32. The trained learning model 37 may be stored in the memory 42 of the analyzing device 40 when used or stored in the memory of another computer included in the information processing system 11.

The training data 36 is used to update various weightings when training the learning model 37. The training data 36 may include validation data and test data. The validation data is used to, for example, tune hyperparameters. The test data is used to, for example, assess the performance of the trained learning model 37.

The processors 21, 31, and 41 include, for example, computations unit such as a Central Processing Unit (CPU), a Graphics Processing Unit (GPU), and a Tensor Processing Unit (TPU). Each of the processors 21, 31, and 41 corresponds to processing circuitry operable to execute various software processes. The processing circuitry may include dedicated hardware circuitry, such as an application-specific integrated circuit (ASIC), for executing at least part of the software processes. That is, the software processes may be executed by processing circuitry that includes at least one or more software processing circuits or one or more dedicated hardware circuits.

Each of the memories 22, 32, and 42 is a computer-readable medium. Each of the memories 22 and 32 includes, for example, a non-transitory storage medium such as a Random Access Memory (RAM), a Hard Disk Drive (HDD), a flash memory, or a Read Only Memory (ROM).

When a signal is received or when a predetermined condition is satisfied, the processors 21, 31, and 41 execute a series of commands included in the programs stored in the corresponding memories 22, 32, and 42. The service server 20, the information processing device 30, and the analyzing device 40 may each use the data stored in a separate device, for example, the memory of a cloud server (not shown).

### Analysis of Each Phase

The main purpose of the first phase is to categorize the users 14. More specifically, the analyzing device 40 is operable to categorize the users 14 of one or more services into multiple groups based on multiple indicators. Such categorized groups are referred to as segments, and categorizing is referred to as segmentation. The segments may be set for business domains related to one or more services.

The main purpose of the second phase is to analyze attributes of the users 14 belonging to each of the segments. For example, each segment categorized based on service usage includes various attributes of the users 14. To effectively perform marketing, the users 14 that are targets of marketing strategies need to be selected. Thus, as an example of an analysis, the attributes of the users 14 belonging to each segment are analyzed to extract a group of users having a common characteristic. A user group of a common characteristic is referred to as a cluster, and characterizing the users 14 into clusters is referred to as clustering.

In the second phase, the analysis may include the inference of transition attributes related to transitioning users. Transitioning users refer to the users 14 who will transition from one segment to another segment as time elapses. Among the attributes that the users 14 have, a transition attribute is characteristic to a transitioning user.

A route of transition from one of the segments to another segment is referred to as a transition path. Data distinguishing a transitioning user from the other users 14 in each transition path may include, for example, a data item in which a transitioning user is labeled “0” and a non-transitioning user 14 is labeled “1.”

The analyzing devices 40 may be operable to infer transition attributes characteristic to a transitioning user. A transition path that is subject to analysis is referred to as a target transition path, and a segment that is subject to analysis or a marketing strategy is referred to as a target segment. The target segment is a transition originating segment that is the origin point of a transition. The segment that becomes the terminating point of a transition is referred to as a transition destination segment. One or more target transition paths or target segments may be set. Alternatively, all segments and all transition paths may be analyzed, and the results may be compared.

The analyzing device 40 is operable to extract, from the users 14 of a user group belonging to the target segment, those having a transition attribute as transitional users. A transitional user has an attribute that is the same as or similar to a transition attribute of a transitioning user (interest, concern, or price preference). A transitional user is a potential user who has a high likelihood of transitioning to an upper-level segment when prompted to use a service through a marketing strategy. A transitional user may be found when analyzing or planning a scheduled marketing strategy. In contrast, a transitioning user is a user 14 who has an actual transitioning history and is found by analyzing past data.

The main purpose of the third phase is to expand the target group. The target group is a group of the users 14 targeted by a marketing strategy such a sales-promoting activity. More than one target group may be set. The target group may be set in correspondence with one or more transition paths of one or more transition originating segments. Further, multiple strategies may be prepared for the users 14 included in a single target group.

The target group may include at least some or all of the transitional users. The phrase of “expansion of a target group” also covers the extraction of the users 14 who will be added to the target group when there are not enough transitional users in the target group. More specifically, subsequent to the extraction of the transitional users, one or more similar users are extracted from the users 14 remaining in a transition originating segment and then added to the target group. The similar users are the users 14 having one or more attributes similar to the transition attributes.

The number of the users 14 in the target group (target users) is set in accordance with the scale or budget of the marketing strategy. The target group basically includes the transitional users and the similar users. The similar users are extracted to complement the target group. Thus, the number of the similar users is obtained by subtracting the number of the transitional users from the total number of users in the target group.

The purpose of the fourth phase is to analyze strategic data related to a strategy. In the fourth phase, the results of one or more marketing strategies are predicted or inferred, and the strategic data is analyzed with the predicted or inferred result. The strategic data may include prediction data of a prediction to which one of the segments the users 14 belonging to the target segment will transition.

The analyzing devices 40 may calculate the cost effectiveness of a strategy based on the strategic data. When analyzing multiple target groups, the cost effectiveness of each target group is compared. Further, the analysis result of the strategic data may be fed back to other phases to plan the next strategy.

### Data Used for Analysis

The analysis database 15 may include, as one example of a service usage history, a data item generated based on multiple behavior indicators. One example of a behavior indicator is an indicator related to usage history of one or more services provided by the service servers 20. The behavior indicator may be set for each service or indicate use of multiple services (cross-platform usage). In the present disclosure, the indicators used for segmentation are referred to as segmentation indicators. The behavior indicators may be used as the segmenting indicators.

The one or more services include, but are not limited to, one or more of a point-program service, a credit card service, an electronic payment service, a commercial transaction service (including online shopping), a travel business service (including accommodation reservation and ticket sales), a communication service, a banking service, a securities trading service, and an insurance service. A point-program service is a service where points having added value, including monetary value, are rewarded in accordance with the usage of one or more services. For example, in a group of services using common user IDs and having a point-program service, the behavior indicator may be monthly cross-platform usage, service usage frequency, earned points, redeemed points, expired points, or Life Time Value (LTV).

Examples of behavior indicators related to a credit card service and electronic payment service include, but are not limited to, monthly expenditure and monthly usage frequency. Further examples of credit cart service behavior indicators include monthly installment payment, revolving payment, other payment plans, and paid service renewal frequency. Further examples of electronic payment service behavior indicators include monthly payment, prepaid means payment, coupon usage frequency, and coupon-discounted amount.

Examples of behavior indicators related to a personal commercial transaction service include, but are not limited to, payment amount, maximum payment of purchased products, number of purchased products, and number of products in listing. Example of behavior indicators related to a travel business service include, but are not limited to, monthly accommodation fees, travel distance from residence, domestic travel expenditure, and overseas travel expenditure. Example of behavior indicators related to a communication service (e.g., mobile communication or optical communication for cell phones, smartphones, or tablets) include, but are not limited to, monthly data usage amount, talk time, amount paid, feature fees, and subscription renewal frequency.

Examples of behavior indicators related to a banking service include, but are not limited to, monthly remittance to another bank or another account, remittance frequency, and credit card bill payment. Example of behavior indicators related to a securities trading service include, but are not limited to, monthly purchase or deposit of financial products (e.g., mutual funds, stocks, or bonds) and saving amount paid through prepaid means. Example of behavior indicators related to an insurance service include, but are not limited to, monthly payment of insurance product and monthly payment for each insurance type (e.g., general insurance or short-term insurance).

The segmenting indicators may include indicators related to different services. For example, the segmenting indicators may include an indicator related to a point-program service or an indicator related to any one of a credit card service, an electronic payment service, a commercial transaction service, a travel business service, a communication service, a banking service, a securities trading service, and an insurance service. Alternatively, the segmenting indicators may include an indicator related to two or more of a credit card service, an electronic payment service, a commercial transaction service, a travel business service, a communication service, a banking service, a securities trading service, and an insurance service.

### First Phase: User Categorization

The analyzing device 40 is operable to categorize the users 14 into groups, based on two or more segmenting indicators, and output the categorization result. For example, the program code 45 of each analyzing device 40 includes a categorizing code causing the corresponding processor 41 to read data related to the users 14, categorize the users 14 into segments, and output the categorization result. The users 14 in each segment may be further categorized into groups. The analyzing device 40 performs categorization multiple times to narrow, in a stepped manner, the characteristics of the users 14 in each group.

The categorizing result may include at least numerical values or text indicating an affiliated group or include data in the form of a graph or chart indicating volumes of groups. The output format may differ in accordance with the categorizing method. When the categorizing result includes data in the form of a graph, the program code 45 includes graph output code configured to have the corresponding processor 41 output one or more graphs indicating the distribution of the users 14 in each segment.

The program code 45 may include a save code that has the corresponding processor 41 save the categorizing data as the output result 46 indicating which one of the segments each of the users 14 belonged to over different periods. The save code may also be configured to have the corresponding processor 41 add the categorizing data as part of the user data to the analysis databases 15.

The categorizing code may be configured to have the corresponding processor 41 categorize the users 14 based on multiple segmenting indicators. The segmenting indicators include a frequency indicator related to frequency of use of each of the services, and a quantitative indicator related to expenditure on each of the services. The frequency indicator is one example of a behavior indicator of the users 14. Each of the segmenting indicators includes boundary values set so that adjacent ones of the segments are seamlessly continuous. In other words, the boundary values are set so that the loss of data and the overlapping of data do not occur between segments.

For example, when using two or three segmenting indicators to categorize the users 14, a graph having two axes (e.g., horizontal axis serving as first axis and vertical axis serving as second axis) may be used to indicate the categorizing result. This will facilitate visual understanding. The first axis may represent a Key Performance Indicator (KPI), which has the greatest weight. The third segmenting indicator may be visualized on a two-dimensional graph by expressing volume with bubble size in a bubble chart or by changing the color or color tone of a figure (e.g., circle). When the categorizing result is not visualized with a graph, four or more segmenting indicators may be used to categorize the users 14.

The categorizing conditions are set so that categorizing is performed in a manner that the volume difference or dispersion between segments will be suitable. For example, an indicator allowing a category to be expressed with a numerical values may be used to allow for volume adjustment of each segment. The program code 45 may include a combination of preset indicators, used to suitably perform categorization, and boundary values, used for categorization. Further, the program code 45 may include patterns of indicator patterns that are selectable.

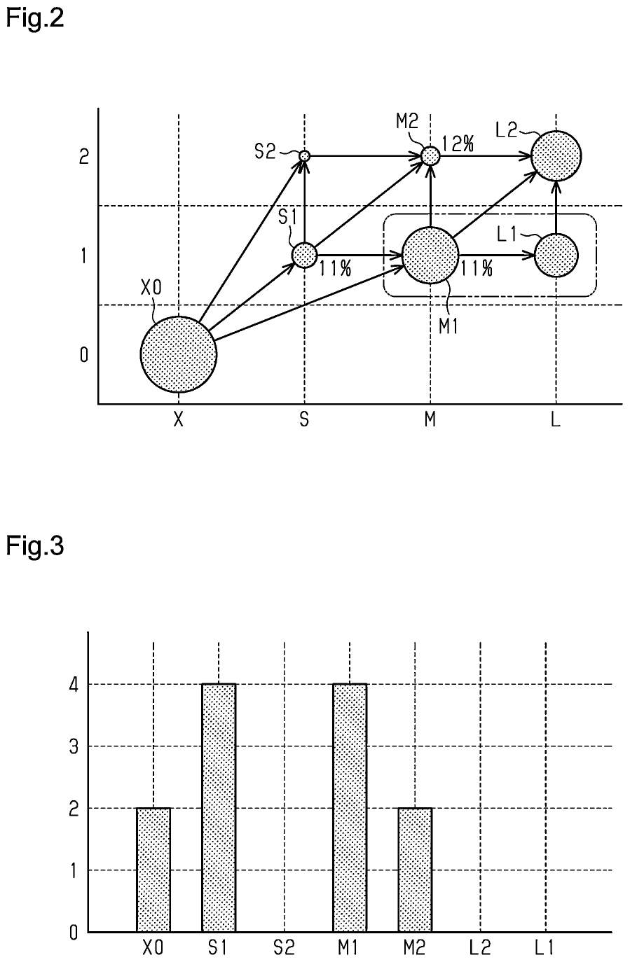

FIG. 2 is a graph showing a categorizing result of the users 14 segmented based on expenditure on and usage frequency of a service. In the data related to the expenditure and usage frequency of a service, boundary values are set so that the loss of data and the overlapping of data do not occur between segments. Numerical value data may be converted into a value input to a categorizing data item by using boundary values or numerical ranges for dividing numerical values. The input value may include alphabet characters, numbers, and symbols.

In the example of FIG. 2, the vertical axis represents the expenditure on a service, which is a quantitative indicator. The expenditure is, for example, the expenditure over a specific period (e.g., one month), and the boundary values are set to specific amounts of money (e.g., 0 yen and 10,000 yen). One of three types of data (e.g., 0, 1, or 2) are input to categorizing data items related to expenditure. For example, “0” indicates no expenditure (0 yen), “1” indicates an expenditure of less than 10,000 yen, and “2” indicates expenditure of 10,000 yen or more.

In the example of FIG. 2, the horizontal axis represents the usage frequency of a service, which is a frequency indicator. The usage frequency is the usage frequency over a specific period (e.g., one month), and the boundary values are set to one time and ten times. One of four types of data (e.g., X, S, M, or L) are input to categorizing data items related to usage frequency. For example, X indicates usage of less than one time (0 times), S represents usage of one time, M represents usage of two to nine times 9 (more than once and less than ten times), and L represents usage of ten or more times.

In the example of FIG. 2, the users 14 are categorized into seven segments based on two segmenting indicators. In the graph of FIG. 2, the bubbles are sized in proportion to the number of users to visualize the volume of each segment. In FIG. 2, the users 14 in the lower left segment (e.g., first segment X0) are light users, and the users 14 in the upper right segment (e.g., seventh segment L2) are heavy users. The first segment X0 is a group of users who have not used the service in a subject month.

The users 14 who have not used the service over a certain period like those in the first segment X0 are referred to as dormant users. In this manner, the segments may include a segment of dormant users who have not used the service over a certain period. Instead or in addition, the segments may include a segment of new users who have no usage history of the service.

Second segment S1 is a group of users who have used the service once and spent less than 10,000 yen during the subject month. Third segment M1 is a group of users who have used the service two to nine times and spent less than 10,000 yen during the subject month. Fourth segment L1 is a group of users who have used the service ten or more times and spent less than 10,000 yen during the subject month. Fifth segment S2 is a group of users who have used the service once and spent 10,000 yen or more during the subject month. Sixth segment M2 is a group of users who have used the service two to nine times and spent 10,000 yen or more during the subject month. Seventh segment L2 is a group of users who have used the service ten times or more and spent 10,000 yen or more during the subject month.

### Second Phase: Analysis of User Attributes

The analyzing device 40 may be operable to analyze the attributes of the users 14 belonging to a target segment and output the analysis result. In one example, the analyzing devices 40 may extract, from the users 14 included in a target segment, a group of users having a common characteristic (attribute) as a cluster. Clustering may be performed with a learning model using an algorithm such as k-means.

From the many attributes that the users 14 have, attributes that are common characteristics may be selected during clustering. In one example, the users 14 in each segment may be classified into clusters based on attributes that do not vary or vary seldomly such as gender, age, residence, income, or family structure. Further, the percentage of the number of users in each cluster occupying the corresponding segment may be calculated. This allows the attributes that many users 14 have in each segment to be known.

Further, for example, a group having a high occupying percentage in the target segment may be compared with a group having the same characteristics in another segment. Alternatively, the occupying percentage of a specific group (e.g., group of unmarried males) may be compared between the target segment and the total users. For example, when considering a marketing strategy targeting a specific group of users, the group of users may be analyzed in further detail.

The analyzing device 40 may perform the same categorization using the same indicator every certain period (e.g., one month). This allows for analysis of the attributes that the users 14 staying in the same segment have or analysis of the attributes that the users 14 changing to other segments (transitioning users) have. Such analysis of the transitioning situation may be conducted on the users 14 belonging to one or more clusters.

With regard to segments M1 and L1 in the box indicated by double-dashed lines in FIG. 2, a transition path extends from segment M1 to segment L1 as indicated by the arrow. In this manner, the one or more graphs output by the graph output code may include the display of the transition history of the users 14. FIG. 2 shows examples of transition paths between adjacent ones of the segments in which transitioning proceeds in the arrowed direction of increasing usage frequency and expenditure. In FIG. 2, the percentage of the users 14 who transitioned to another segment over the past month are indicated for some of the transition paths.

In contrast, analysis may be performed on transitioning that occurs in an arrowed direction in which the usage frequency or expenditure decreases. When there is a tendency of a declining transition, the causes can be analyzed to plan a marketing strategy that reduces such declining. In addition, transition paths between non-adjacent segments may be analyzed in the same manner.

Such analysis may also be performed by sampling a specified number of the users 14 in each segment. Alternatively, for users who are dormant this month, usage throughout the year or the transitioning tendency within each segment may be checked. In addition, transitioning may be analyzed by separating new users who have recently started usage from existing users who started usage a certain time ago.

The example of FIG. 2 may be used to analyze the volume and chronological change of each segment but may also be used to analyze the transitioning tendency of the users 14 included in each segment to check the transitioning situation over a longer period. For example, the analyzing device 40 may determine the number of months per year during which each user 14 belonged to each segment, and output data that relates to the frequency each user 14 belonged to the segment.

FIG. 3 is a bar graph showing an example of the number of months in a certain year during which the users 14 belonged to segments X0, S1, S2, M1, M2, L1, or L2. By using such a graph to show data, the analysis results can be visualized. The bar graph allows the transitioning tendency of the users 14 to be understood.

A bar graph or a line graph may be used to analyze the increase and decrease of the number of users and proportion of users in each segment over a longer term. In this case, the vertical axis may represent the number of users and proportion of users in each segment, and the horizontal axis may represent the time elapsed (e.g., months). In such a graph, the transitioning tendency over a longer term can be visualized.

The segmenting indicators used for categorizing may include indicators related to different services. For example, when a party providing a certain service starts to provide a new service, a strategy prompting existing users to use the new service may be planned. In such a case, the user group of an existing service is the analysis target, and most of the users 14 are potential users who have not yet used the service when the new service is started.

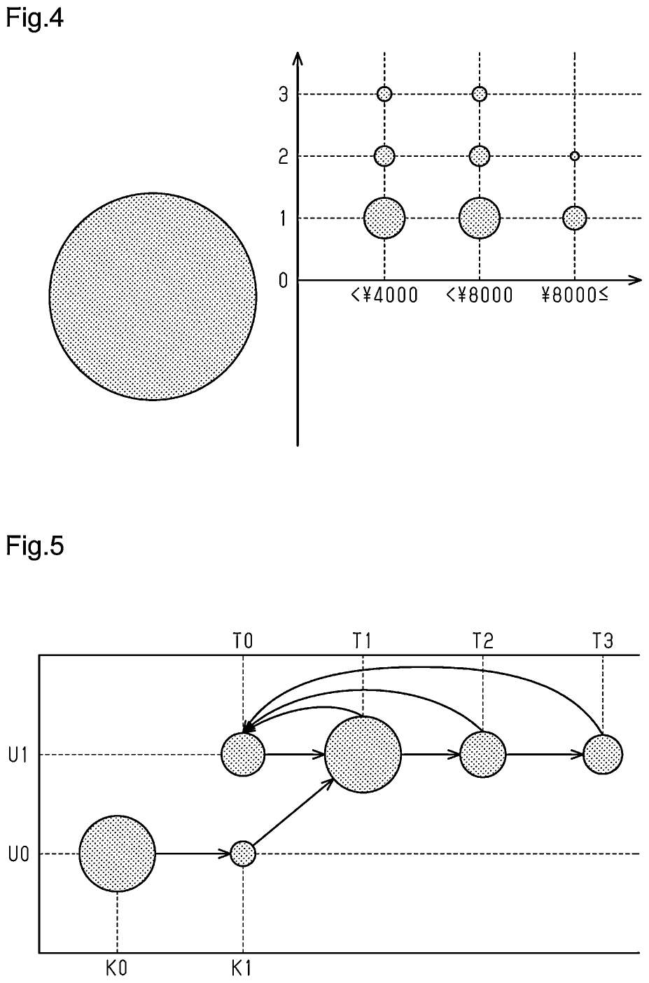

FIG. 4 is an example of a graph showing the volume of each segment and, in particular, can be used to show the transitioning situation when most of the users are potential users. In FIG. 4, the vertical axis represents usage frequency, and the horizontal axis represents expenditure. In FIG. 4, the left side of the vertical axis shows a segment of users who have not yet used the service, and the right side of the vertical axis shows segments of users who have used the new service. In the graph, users who have not yet used the service are shown separately to allow for comparison with the other users 14.

As shown in FIG. 5, segmentation may be performed using the transitioning situation and the service usage situation as indicators. FIG. 5 shows an analysis proposal when a party providing a certain service starts to provide a new subscription service. In FIG. 5, the vertical axis (second axis) represents two values, existing users U1, who have used the new service, and non-users U0, who have not used the service. The first axis (most important KPI) of the existing users U1 represents the service continuation period (T0: service stopped, T1: within one month, T2: one to three months, T3: over three months). The first axis of the non-users U0 represents the awareness of the new service (K1: aware, K0: not aware).

One or more personas, which are fictional user characters, may be set to perform clustering. For example, three clusters C1, C2, and C3 may be set as different targets of a marketing strategy. The persona profile set for cluster C1 is, for example, “age in twenties or thirties,” “employed,” “residing in rented accommodation,” “unmarried,” “drinks alcoholic beverages in restaurants,” and “frequently uses electronic payment in convenience stores.” The persona profile set for cluster C2 is, for example, “age in forties or fifties,” “employed,” “homeowner,” “married with child,” “drinks beer,” and “car owner.” The personal profile set for cluster C3 is, for example, “female aged 35 to 45 years old,” “homeowner,” “married with child,” “car owner,” “purchases skin-care products and cosmetics.”

The analyzing device 40 may be operable to infer a transition attribute as one example of an analysis. For example, the program code 45 of the analyzing device 40 may be an inference code configured to have the processor 41 infer, from the attributes of the users 14, one or more transition attributes that are characteristic to a transitioning user who transitions to another segment as time elapses.

The inference of a transition attribute may be performed on an entire target segment or on one or more clusters included in a single cluster. When a cluster is subject to the transition attribute inference, some of the user attributes have already been limited through clustering. This facilitates the analysis of the transition attributes, especially, when there are many user attributes. Further, the transition attributes related to a single transition path may be inferred from a single segment or a single cluster. Alternatively, the transition attributes related to some or all of the transition paths may be inferred.

A trained learning model may be used to infer the transition attributes. The learning model may be the learning model 37U generated by the information processing device 30. In this case, the inference code may include an input code. The input code may be configured to have the processor 41 input user data that includes the attributes of each user 14 to the learning model 37U. The learning model 37U may be configured so that when the user data is input, the result of the prediction of whether the user 14 will become a transitioning user and the importance of each attribute in the prediction are output as calculation results.

The learning model 37U may be a neural network model trained to predict whether a user 14 related to the input user data will become a transitioning user. The importance of each attribute in the prediction may be the probability that a user will become a transitioning user. Boosting, such as eXtreme Gradient Boosting (XGBoost), may be used as an algorithm for predicting whether a user 14 will become a transitioning user.

A method for generating the learning model 37U includes acquiring training data and training a pre-trained learning model with the training data. The training data includes user data and a ground truth label for each user 14 included in the user data to indicate whether the user 14 is a transitioning user.

XGBoost is one example of an algorithm for ensemble learning and is a model combining boosting and decision trees. When training the learning model 37U, the history data of the transitioning users belonging to the target segment is used as ground truth data. When the attribute data of a certain user 14 is input, the trained learning model 37U outputs a result predicting whether the user 14 will transition to another segment.

The importance of each attribute in the prediction, that is, the impact or importance of each feature, may be output as a SHapley Additive explanations (SHAP) value based on Shapley Values applied to machine learning. SHAP values quantify the contribution of each feature to the prediction. The output of the quantified contribution of each feature is an additional functionality of the learning model 37U. The inference code is configured to use the output result of the additional functionality to infer transition attributes.

In this analysis, among the calculation results of the learning model 37U, the SHAP value, which is the importance of each attribute in the prediction, is needed, not the prediction of “whether a transition will occur.” Thus, the past data of actual transitioning users should be input to the learning model 37U, not the user data of the target segment subject to prediction of future transitioning. In this case, user data including transition situation and used as training data of the learning model 37U may be divided into verifying data, test data, and prediction data before training the learning model 37. After checking the versatility of the learning model 37U with the verifying data and the test data, the prediction data may be input to the learning model 37U to acquire the calculation result.

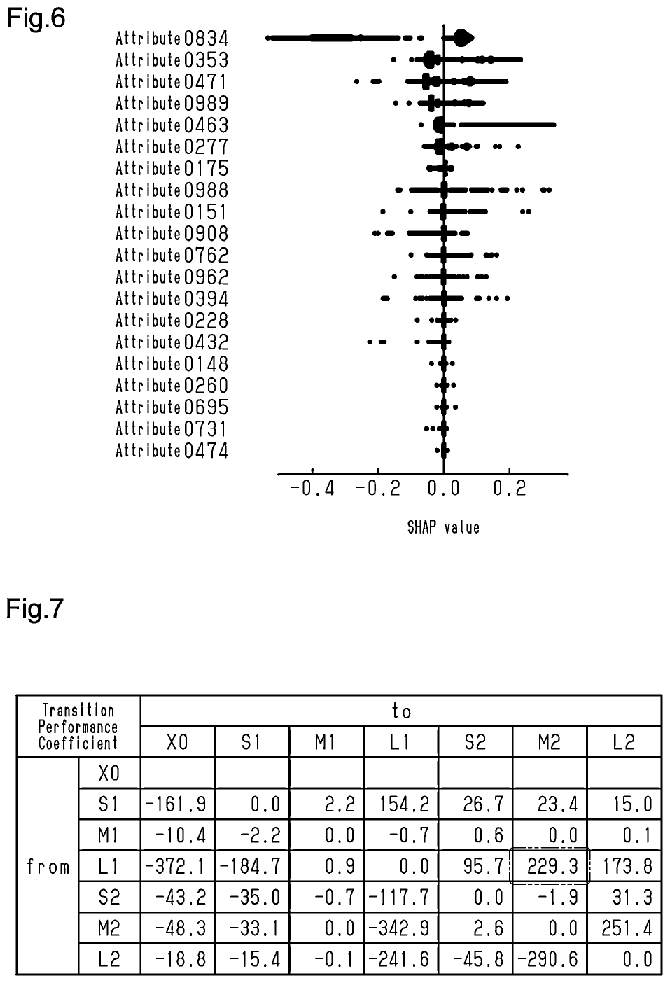

FIG. 6 shows one example of the result outputting the importance of features as SHAP values. A SHAP value indicates that transition is more likely to occur as it becomes larger and farther from 0 and indicates that transition is less likely to occur as it becomes smaller and farther from 0. Thus, a feature having a larger SHAP value will indicate that the feature is important for transition. FIG. 6 shows the SHAP values of multiple features, with the horizontal axis representing the SHAP value. The vertical axis includes data labels (attribute+four-digit value) representing features of different attributes (attribute values). In FIG. 6, features of greater importance are listed at higher positions in the vertical axis, and features of less importance of less importance are listed at lower positions in the vertical axis. The program code 45 or the learning model 37U may be configured to output a graph such as that of FIG. 6 as part of the calculation result.

The inference code may be configured to output, from the output features, one or more (e.g., two to three) features having high SHAP values as the inferring result of one or more transition attributes characteristic to a transitioning user. In this case, instead of outputting transition attributes based on only the SHAP values, for example, transition attributes may be selected giving priority to target users of marketing strategies or attributes related to target users (e.g., usage history of service). The inference code may further be configured to extract, from the target segment (at least one transition originating segment among multiple segments or cluster in target segment), users having one or more transition attributes as the transitional users.

### Third Phase: Expansion of Target Group

The analyzing device 40 may execute a process for expanding the target group and output the processing result. The analyzing device 40 reads the program code 45 and executes a process for expanding the target group based on the program code 45. More specifically, the program code 45 may include an acquisition code and an extraction code. The acquisition code is configured to have the processor 41 acquire user data including data of the users 14. The user data may include attribute data indicating attributes that each user 14 has and the output results of the first and second phases. For example, the user data may include categorizing data indicating which one of the segments each user 14 belonged to during each period, and data indicating whether each user 14 is a transitioning user or a transitional user.

The extraction code may be configured to have the processor 41 extract one or more the similar users from the segment from which the transitional users were extracted. In other words, the analyzing device 40 extracts, from the target segment (or from cluster in target segment), one or more similar users having one or more attributes similar to the transition attributes. For example, in FIG. 2, when planning a marketing strategy for transitioning the users 14 in the third segment M1 to the fourth segment L1, the third segment M1 is the target segment.

The one or more attributes similar to the transition attributes are referred to as similar attributes. The method for outputting the attribute similarity of a transitioning user, who has a transition attribute, and another user 14 may be rule-based. Alternatively, the similarity may be calculated with the learning model 37T.

The extraction code or the learning model 37T may include a conversion code and a calculation code. The conversion code is configured to convert the attributes of the transitional users into vector representations in feature space, embedded space, or potential space. The calculation code is configured to calculate the similarity between vectors (distance between datasets in vector space). The extraction code or the learning model 37T may be configured to extract the similar users based on the similarity. In this case, the similarity between vectors can be calculated by using, for example, Euclidean distance or cosine similarity.

The conversion code is an encoder for obtaining a vector representation. One example of such an encoder may be, but is not limited to, a transformer encoder, which is one example of the learning model 37T. Another example of an encoder is a Graph Neural Network (GNN).

Examples of GNN include a knowledge graph and a Graph Convolutional Neural Network (GCNN).

In one example, the attributes of every user in the transition originating segment may be converted to a vector representation. With respect to the transitional users (or transitioning users), the cosine similarity of the other users 14 is calculated. Then, vectors with a similarity greater than a predetermined threshold value or a specified number of vectors in order of those having a higher cosine similarity are selected. In this case, the users 14 corresponding to the selected vectors are extracted as the similar users having attributes similar to the one or more transition attributes.

Extraction conditions, such as the number of similar users and the similarity threshold value, may be optimized when necessary. When limiting the users 14 to those with a higher similarity, the number of the similar users will become small. When increasing the similar users, users 14 having a relatively small similarity will be extracted as the similar users. The extraction conditions may be changed in accordance with, for example, the volume of the target group and the content or cost of the marketing strategy.

The extraction code or the learning model 37T may include a target output code. The target output code is configured to have the processor 41 output the target group. The target group includes transitional users and one or more similar users. Thus, the target group is output including the transitional users having transition attributes and also the similar users having attributes similar to the transitional users.

### Fourth Phase: Analysis of Strategic Data

The analyzing device 40 may use strategic data to execute a process for calculating the cost effectiveness of a planned strategy and output the processing result. Further, the analyzing device 40 may execute a process for selecting a transition path that will be the target of a strategy and output the processing result. For example, a transition performance coefficient (segmentation transition performance coefficient) obtained by executing a marketing strategy may be calculated for every one of the transition paths. The transition performance coefficient is one example of an economic performance index.

In accordance with an analysis content, an index other than the transition performance coefficient may be used to forecast the economic performance.

The program code 45 may be a forecast code configured to have the processor 41 forecast the economic performance resulting from transition of the users 14. The forecast code may include calculating the transition performance coefficient. The transition performance coefficient indicates the economic performance when transition from one of the segments to another segment occurs. The forecast code may include comparing the transition performance coefficients of different transition paths to output the ones of the transition paths having a higher economic performance.

The transition performance coefficient may be calculated under the assumption that all or some of the users 14 in each segment will transition to another segment. For example, when some of the users 14 in a segment transition to another segment, a tentative transition probability (e.g., 5% of all users) may be set.

The transition probability of the users 14 may be estimated through a learning model. The learning model may be a first learning model 37E generated by the information processing device 30. In this case, the forecast code may include an input code. The input code may be configured to have the processor 41 input the user data to the first learning model 37E. The user data includes information related to the segment (segment i) to which each user belongs during a certain month and the segment (segment j) to which each user belongs the next month.

A method for generating the first learning model 37E includes acquiring training data and training a pre-trained learning model with the training data. The first learning model 37E is configured to, for example, convert the data of the transitioning users transitioning from one of the segments to another segment into a probability distribution through normalization. When the user data is input, the first learning model 37E is configured to output the probability of the users 14 transitioning from one segment to another segment.

The transition performance coefficient may be calculated through a learning model. The learning model may be a second learning model 37E generated by the information processing device 30. In this case, the forecast code may be configured to have the processor 41 provide input data to the second learning model 37E.

The input data and training data input to the second learning model 37E may include first input data and second input data. The first input data may include, for example, the number of transitioning users transitioned through a certain transition path during a certain period. The second input data may include a value indicating the quality of the transitioning users in the certain transition path. The second input data is, for example, the average sales in a certain segment. When the input data is input, the second learning model 37E is configured to output the transition performance coefficient of a certain transition path as expressed in equation (4), which will be described later.

The second learning model 37E may be configured to forecast, from the first input data and the second input data, the value that a user 14 will have in the coming year, for example, annual expenditure as one example of economic performance. The annual expenditure of a user may be an estimated value estimated through equation (2), which will be described later. The annual expenditure may be used to calculate gross merchandise volume, profit, or investment return.

In following equations (1) to (4), T represents a segment transition matrix used to calculate the transition probability of the users 14, and tᵢⱼ represents a segment transition matrix indicating the transition rate from segment i to segment j. Further, s represents average monthly expenditure, si represents the average monthly expenditure in segment i, nᵢ represents the number of users in segment i, and u represents a user vector. If the user vector is target segment i, uᵢ=1 is satisfied, and if not, uᵢ=0 is satisfied.

The expenditure of a certain user 14 in segment i during a certain month (m) is calculated with following equation (1).

$$Equation 1$$

$${\hat{s}}_{i}^{m} = {u}^{T} {T}^{m} s \qquad ( 1 )$$

The annual expenditure of a certain user 14 in segment i is calculated with following equation (2).

$$Equation 2$$

$${\hat{s}}_{i}^{y} = {\sum }_{m = 1}^{12} {\hat{s}}_{i}^{m} \qquad ( 2 )$$

The transition difficulty from segment i to segment j is calculated based on the first input data with following equation (3).

$$Equation 3$$

$$\frac{{t}_{ij}}{{\sum }_{i , j} {t}_{i , j}} \qquad ( 3 )$$

The difference between the annual expenditure in segment i, which is calculated with equation (2), in segment j, the transition difficulty calculated with equation (3), and the scale of segment transition are multiplied as expressed in equation (4). This calculates the transition performance coefficient of transition from segment i to segment j.

$$Equation 4$$

$${c}_{ij} = ( {\hat{s}}_{i}^{y} - {\hat{s}}_{j}^{y} ) \cdot \frac{{t}_{ij}}{{\sum }_{i , j} {t}_{i , j}} \cdot \frac{{n}_{i}}{{\sum }_{i} {n}_{i}} \qquad ( 4 )$$

As shown in FIG. 7, for each of the seven segments X0, S1, M1, L1, S2, M2, and L2, the service expenditure (sales) in a specified period (e.g., one month) may be calculated in order to calculate an increase in sales when a user 14 transitions from one segment to another segment as the transition performance coefficient.

In the example of FIG. 7, when transitioning from the fourth segment L1 to the sixth segment M2, the transition performance coefficient is 229.3 and higher than the transition performance coefficient of other transition paths. Thus, the analyzing device 40 may output the transition path from the fourth segment L1 to the sixth segment M2 as a transition path having a high economic performance. The transition paths may all be analyzed in an initial strategy planning stage and then further detailed analysis may then be performed in stages.

The analyzing device 40 may be operable to evaluate how the transition performance coefficient will change in a transition path that is a target of a strategy. An increase in sales may be expected when a strategy is directed to a segment having a large volume. However, the cost of the strategy may be high. For example, even if sales increase and become the highest when transitioning from the fourth segment L1 to the sixth segment M2, a large cost may be necessary for the strategy prompting transition in which case the cost effectiveness will be low.

In this respect, for example, the relationship of the strategy cost, which varies in accordance with the scale of the transition originating segment, and the transition performance coefficient may be analyzed to find the transition path having the highest cost effectiveness. In this case, the strategic data analysis may be performed while changing the analysis conditions in other phases. For example, in the first phase, segmentation may be performed on patterns of segments having different scales to evaluate the tradeoff between the transition performance coefficient and the strategy cost. Alternatively, to evaluate how the transition performance coefficient changes in accordance with the scale of the target group, in the third phase, target groups of different users may be extracted from a target segment to calculate and compare the transition performance coefficient of each target group.

In one example that will now be described, the analyzed data is related to a strategy targeting a group in the transition path from the third segment M1 to the fourth segment L1. In this example, the target group includes three user groups respectively corresponding to the three clusters C1, C2, and C3.

Different marketing strategies are prepared for the three clusters C1, C2, and C3. For example, a strategy prompting use of electronic payment in a restaurant is prepared for cluster C1, and a strategy for increasing credit card usage frequency is prepared for cluster C2. Further, a strategy prompting use of electronic payment in a specific family restaurant is prepared for cluster C3. A strategy is, for example, the allocation of service points based on the amount spent on a subject service during campaign period.

In one example, it is assumed that 5% of a target group will become transitioning users and transition to the fourth segment L1. In this case, the number of the transitioning users is calculated, and the Gross Merchandise Sales (GMS) or profit is calculated as the economic performance. The Return On Investment (ROI) may also be calculated as the economic performance taking into consideration the strategy costs. The annual expenditure calculated with equation (2) may be used to calculate gross merchandise volume, profit, or investment return. The forecast code compares the economic performance of each strategy and outputs the strategy that is more economic that the other strategies.

### Method for Processing Information

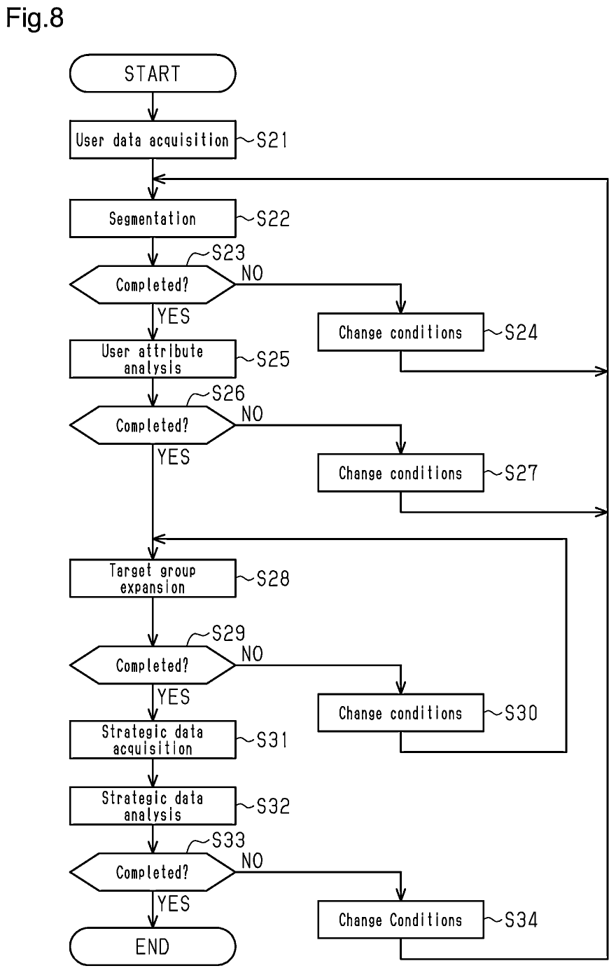

FIG. 8 is a flowchart illustrating the procedures of a method for processing information in accordance with the present embodiment. The analyzing device 40 reads the program code 45 and executes the processing illustrated in FIG. 8 based on the program code 45. As shown in FIG. 8, the processor 41 may successively execute the processes of segmentation (step S22), user attribute analysis (second phase, step S25), target group expansion (third phase, step S28), and strategic data analysis (fourth phase, step S32). Instead of successively executing the processes corresponding to the first to fourth phases (steps S22, S25, S28, and S32), the processor 41 may execute only one or some of these processes.

The segmentation (step S22) is a categorizing process corresponding to the process of the first phase. The user attribute analysis (step S25) may include an inference process that is for inferring one or more transition attributes and corresponds to the second phase. The target group expansion (step S28) may include a process for outputting the target group of the third phase (output step). The strategic data analysis (step S32) may include a forecasting process that is for forecasting the economic performance resulting from transitions and corresponds to the fourth phase.

The processor 41 may execute one of the four processes (categorization process, inference process, outputting process, and forecasting process) and then feed back the result of the executed process to any of the remaining three processes. In this case, the processor 41 may re-execute the process that received the feedback.

After each of steps S22, S25, S28, and S32, the processor 41 may perform a process for determining whether the corresponding process has been completed (steps S23, S26, S29, and S33). In steps S23, S26, S29, and S33, the processor 41 determines whether the corresponding process has been completed based on a condition for determining whether the output result of step S22, S25, S28, or S32 is proper. When steps S23, S26, S29, and S33 have not been completed, the processor 41 may change the calculation conditions in following steps S24, S27, S30, and S34. When changing conditions in steps S24, S27, S30, and S34, the processor 41 may automatically change the conditions as set in advance or change the conditions based on inputs from an operator.

With regard to the segmentation (step S22), for example, segmentation threshold values related to the difference or dispersion of volume between segments are set in advance to perform the determination of step S23. When the completion condition is satisfied in step S23, the processor 41 proceeds to step S25. When the completion condition is not satisfied in step S23, the processor 41 changes the segmentation condition in step S24 and then performs the segmentation process again (step S22).

The user attribute analysis (step S25) may include at least one of output of the analysis result including diagrams and inference of transition attributes (inference step). For example, in the inference of transition attributes, a threshold value condition related to SHAP values, the number of attribute combinations, or the number of transitional users may be set. The determination of step S26 may be performed based on whether the condition is satisfied.

When the completion condition is satisfied in step S26, the processor 41 proceeds to following step S28. When the completion condition is not satisfied in step S26, the conditions related to the inference may be changed in step S27. In FIG. 8, after performing step S27, the processor 41 returns to the segmentation of step S22. Instead, the processor 41 may change the analysis condition in step S27 and perform the user attribute analysis again (step S25).

With regard to the target group expansion (step S28), for example, the ratio of the similar users and the transitional users may be set in advance as an extraction condition, and the determination of step S29 may be performed based on whether the extraction condition is satisfied. When the completion condition is satisfied in step S29, the processor proceeds to step S31. When the completion condition is not satisfied in step S29, the processor 41 may change the condition related to the extraction of similar users in step S30 and then perform step S28 (or steps S47 to S49). FIG. 8 shows an example in which the processor 41 performs step S30 and then returns to step S28. Instead, when a negative determination is given in step S29, the processor 41 may change the condition and perform segmentation (step S22) or perform user attribute analysis again (step S25).

With regard to the strategic data analysis (step S32), for example, a significant discrepancy in an evaluation value of a strategy may be set in advance as a threshold condition, and the determination of step S33 may be performed based on whether the threshold condition is satisfied. When the completion condition is satisfied in step S33, processing may be finished. When the completion condition is not satisfied in step S33, the processor 41 may change the condition in step S34 and feed back the changed condition to the preceding processes. FIG. 8 shows an example in which the processor 41 performs step S34 and then returns to step S22. Instead, the processor 41 may change the condition in step S34 and then perform again the user attribute analysis process (step S25), the target group expansion (step S28), or the strategic data analysis (step S32).

Even when the completion condition is satisfied in step S33, the processor 41 may output data that is fed back to one or more of step S22, S25, S28, and S32 before ending processing. For example, after giving an affirmative determination in step S33, the processor 41 may output data for changing one or more analysis conditions included in the first to fourth phases before ending processing.

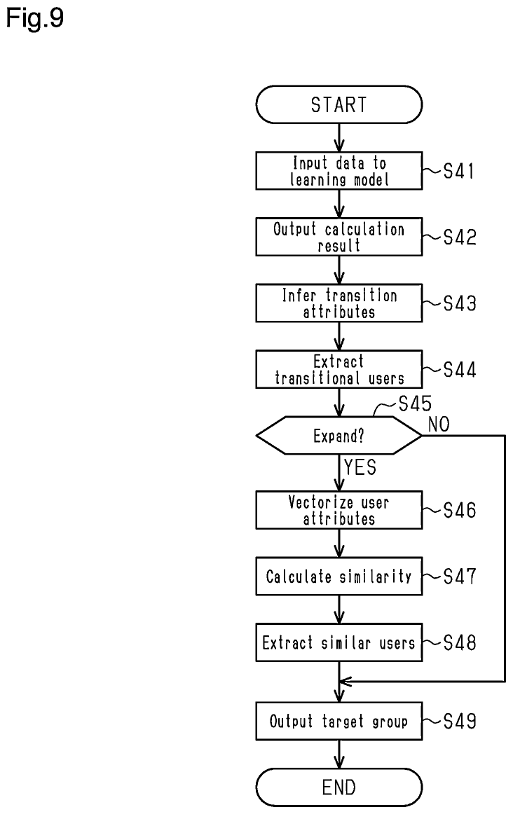

The target group output process includes transition attribute inference, which is part of the second phase, and target group expansion of the third phase (step S28). Thus, instead of successively executing the first to fourth phases of FIG. 8, the processor 41 may solely output the target group in accordance with the flowchart of FIG. 9.

FIG. 9 is a flowchart illustrating the procedures of a method for outputting a target group in accordance with the present embodiment. The analyzing device 40 reads the program code 45 and executes the processing illustrated in FIG. 9 based on the program code 45.

In step S41, the processor 41 first inputs user data to the learning model 37U. Then, in step S42, the learning model 37U outputs a calculation result. The calculation result includes the importance of attributes used to predict whether a certain user 14 will transition to another segment.

In step S43, the processor 41 infers transition attributes based on the importance of the users predicted to transition to another segment. More specifically, the processor 41 selects one or more attributes (attribute values) having high importance.

In step S44, the processor 41 extracts transitional users from the target segment. More specifically, the processor 41 selects, from the users 14 belonging to the target segment, the users 14 having multiple transition attributes. In step S44, the processor 41 may input the user data of the target segment to the learning model 37U and extract the users 14 predicted to become transitioning users as transitional users.

In step S45, the processor 41 determines whether to expand the target group based on the number of transitional users extracted in step S44 and the number of users set as targets of a marketing strategy. When the number of transitional users is less than the set number of users, the processor 41 determines that expansion is necessary and proceeds to step S46. When the number of transitional users is greater than the set number of users, the processor 41 proceeds to step S49. In this case, in step S49, the processor 41 outputs a list of transitional users forming the target group. In step S45, when the number of transitional users is greater than the set number of users, the number of the transitional users may be decreased by, for example, changing the conditions of step S43 or step S44.

In step S46, the processor 41 vectorizes the attributes of the users 14 belonging to the target segment. In step S47, the processor 41 calculates the vector similarity, with respect to the vectors of the transitional users, of the other users 14. In step S48, the processor 41 extracts, from the other users 14, one or more similar users based on the similarity calculated in step S47. Then, in step S49, the processor 41 outputs a user list of the target group including the transitional users and the similar users.

### Operation of Present Disclosure

The users 14 are categorized to narrow the users 14 that will be the targets of a marketing strategy. For example, segmentation may be performed based on segmentation indicators that indicate the service usage situation to understand the distribution of the users 14 with regard to service usage situation. Further, by understanding characteristic user groups in each segment and the number of users in such groups, the user group having the greatest influence or the user group that is most important for business can be found. An influential or important user group may be a significant target candidate that allows marketing activities to be performed effectively.

For example, the inference of transition attributes of transitioning users in a transition path, in which a user transitions from one of the segments to an upper-level segment, allows for the extraction of transitional users having the transition attributes to be extracted as potential users. Further, the extraction of similar users having characteristics similar to those of transitional users allows for adjustment of the number of users in the target group while maintaining the target group with the users 14 having the proper attributes.

When the transitioning users have multiple transition attributes, a user 14 having any one of the transition attributes may be selected as a similar user. A user 14 having an attribute similar to or approximate to any one of the transition attributes may also be selected as a similar user. In this case, however, the influence each transition attribute has on a transition is important for the selection of a similar user. In this regard, in the present embodiment, for example, vector representations are used to extract a user 14 having one or more attributes similar to the transition attributes as a similar user. This allows for a further desirable selection of similar users than when analyzing the attributes of each user 14 separately.

The transition of a user 14 from a segment for low expenditures to a segment for high expenditures is desirable for a party providing a service. Further, the marketing cost-effectiveness will increase when sales-promoting activities are performed targeting transitional users and similar users that are likely to transition to a more desirable segment. In particular, the output of the strategic data analysis result in the fourth phase allows for the cost-effectiveness of multiple marketing strategies to be compared and evaluated. Further, repetitive analysis, while feeding back the output results between the first to fourth phases, allows strategies to be optimized.

### Advantage of Present Disclosure

The present disclosure has the advantages described below.
(1) The learning model 37U allows for the inference of one or more transition attributes characteristic to transitioning users.
(2) The inference code allows for the extraction of transitional users who are potential users from the target segment.
(3) Segmentation of the users 14 based on service usage history allows for proper analysis of the transition tendency.
(4) The use of quantitative indicators and frequency indicators as the segmenting indicators allows for proper analysis of chronological usage situation changes.
(5) The use of segmenting indicators related to multiple services allows for proper analysis of cross-platform usage.
(6) When new users and dormant users are included in a segment, marketing strategies may be planned accordingly to have such users start or restart use of the corresponding service.
(7) The SHAP values used for predictions related to transition attributes quantify the contribution of attributes to the prediction.
(8) The addition of similar users to expand a target group allows the number of users in the target group to be adjusted.
(9) The extraction of transitional users from a target group allows the target group to include users having a high transitioning likelihood.
(10) Similar users have attributes similar to transitional users and have a likelihood of becoming potential users. The transitional users and the similar users are included in a target group to expand and optimize the target group.
(11) The similarity in vector representations are used to extract similar users. Thus, a wide variety of attributes can be quantitatively determined for similarity. Further, attributes can be ranked in order of similarity. This facilitates volume adjustment of the target group.
(12) The economic performance resulting from user transition is forecasted. This allows the marketing performance of multiple marketing strategies to be compared without actually performing the marketing strategies.
(13) The second learning model 37E is used to calculate the transition performance coefficient taking into consideration the number of transitioning users and the quality of transitioning users.
(14) One or more graphs are output. This visualizes user distribution in each segment.
(15) A graph showing the transition history of the users 14 is generated. This visualizes transition between segments.
(16) Repetitive analysis, while feeding back the output results between the first to fourth phases, allows marketing strategies to be optimized.

### Modified Examples

The above embodiment may be modified as described below. The present embodiment and the following modifications can be combined as long as there is technical consistency.

In a first modified example, in the first phase, in addition to categorizing all of the users, a group of users having a specific attribute may be extracted and categorized into an extracted user group. In this case, attributes that do not vary or vary seldomly such as residence or gender may be selected. For example, one or more of the attributes of age, gender, residence, income, and family structure may be selected, and users 14 having the selected attribute may be extracted. For example, segmentation may be performed by extracting a group of users satisfying the conditions of “unmarried” and “male.” Further, segmentation may be performed by extracting a group of users who have “income within a certain range” and satisfies the conditions of “age in forties or fifties” and “homeowner.”

In a second modified example, the analysis performed by the analyzing device 40 does not have to include one or more of the first to fourth phases or may be divided into phases differing from the above embodiment. For example, the second phase may be divided into data analysis, which includes the output of graphs, and transition attribute inference. Alternatively, the output of the target group shown in FIG. 9 may be considered as a single phase.

In a third modified example, in addition to some or all of the first to fourth phases, the analyzing device 40 may perform a further analysis. For example, a phase for evaluating the result of at least one of the first to fourth phases or a phase for feeding back the result to other phases may be added.

In a fourth modified example, a computer program related to one, some, or all of the first to fourth phases may be provided online or offline as a data analysis application. Some of the first to fourth phases may be executed through such an application, and the remaining phases may be executed by the analyzing device 40. For example, a calculating process for an analysis may be executed by the analyzing devices 40, and an output result including graphs may be downloaded.

In a fifth modified example, when the service server 20 provides products and services of multiple business entities through, for example, an online commerce site, some or all of the series of analyses including segmentation may be performed focusing on products or services provided by a specified business entity. The result of such an analysis may be provided to the specified business entity. Alternatively, the specified business entity may be provided with an application having the functionality to perform such an analysis like in the fourth modified example.

In a sixth modified example, the format and type of an output graph, the analysis procedures, and the algorithms in a learning model may be freely changed.

In a seventh modified example, the attribute characteristic to the marketing objective does not have to be transition attributes like in the above embodiment in which a target group is set centering on transitional users having a high transitioning likelihood. For example, attributes having a high correlation with the characteristics of an objective may be inferred and used in an analysis. Such an objective may be promotion to use a specified service, promotion of use in specified area, enlargement of marketing region, search of potential needs, activation of dormant users, gaining new users, and promoting cross-platform usage. In this case, the users 14 with attributes similar to the attributes having a high correlation with the characteristics of the objective are extracted as similar users. Further, the fourth phase may use a performance coefficient corresponding to the objective instead of the transition performance coefficient.

In an eighth modified example, when expanding the target group, instead of or in addition to extracting similar users based on vector or similarity of an attribute, the users 14 that have highly important transition attributes may be extracted as the similar users based on the importance of attributes output from the learning model 37U.

Technical concepts that can be understood from each of the above embodiment and modified examples will now be described.

### [Clause 1]

An information processing system, including:
one or more memories that store computer program codes; and
one or more processors operable to execute processes based on the computer program codes, where
the one or more processors are operable to execute
   a categorizing process for categorizing users into segments, and
   an inferring process for inferring, from attributes of the users, one or more transition attributes that are characteristic to a transitioning user who will transition to another segment as time elapses,
the inferring process includes an inputting process for inputting user data including the attributes of the users to a learning model,
the learning model outputs a calculation result when the user data is input, and
the calculation result includes a result of a prediction of whether each of the users will become the transitioning user, and importance of each of the attributes in the prediction.

### [Clause 2]

The information processing system according to clause 1, where the inferring process further includes extracting, from at least one of the segments, a transitional user having the one or more transition attributes.

### [Clause 3]

The information processing system according to clause 1 or 2, where
the users use one or more services provided by a business entity,
the one or more services include one or more of a point-program service, a credit card service, an electronic payment service, a commercial transaction service, a travel business service, a communication service, a banking service, a securities trading service, and an insurance service, and
the user data includes a usage history of the one or more services.

### [Clause 4]

The information processing system according to any one of clauses 1 to 3, where
the categorizing process includes categorizing the users based on segmenting indicators,
the segmenting indicators include a frequency indicator related to usage frequency of each of the services, and a quantitative indicator related to an expenditure on each of the services, and
each of the segmenting indicators includes boundary values set so that adjacent ones of the segments are seamlessly continuous.

### [Clause 5]

The information processing system according to clause 4, where the segmenting indicators include indicators related to different services.

### [Clause 6]

The information processing system according to any one of clauses 1 to 5, where
the segments include at least one of a segment of new users having no usage history of a service or a segment of dormant users who have not used a service over a certain period. [Clause 7]

The information processing system according to any one of clauses 1 to 6, where the importance of each of the attributes in the prediction is calculated as a SHapley Additive explanations (SHAP) value.

### [Clause 8]

The information processing system according to any one of clauses 1 to 7, where the one or more processors are operable to further execute
an acquiring process for acquiring user data including data of the users, the user data including classification data indicating to which of the segments each of the users belongs during each of multiple periods, and attribute data indicating the attributes of the users,
an inferring process for inferring, from the attributes, one or more transition attributes that are characteristic to the transitioning user who will transition to another segment as time elapses, and
an extracting process for extracting one or more similar users from at least one of the segments, the one or more similar users each having one or more attributes similar to the one or more transition attributes.

### [Clause 9]

The information processing system according to clause 8, where
the extracting process further includes extracting one or more transitional users from at least one of the segments, and
the one or more similar users are extracted from users remaining in the at least one of the segments from which the one or more transitional users are extracted.

### [Clause 10]

The information processing system according to clause 9, where
the one or more processors are operable to further execute a target outputting process for outputting a target group, and
the target group includes the one or more transitional users and the one or more similar users.

### [Clause 11]

The information processing system according to clause 10, where
the extracting process includes a converting process for converting attributes of the one or more transitional users into vector representations, and
the extracting process extracts the one or more similar users based on similarity of the vector representations.

### [Clause 12]

The information processing system according to any one of clauses 1 to 11, where the one or more processors are operable to further execute a forecasting process for forecasting an economic performance when user transition occurs,
the forecasting process includes
   calculating a transition performance coefficient that indicates the economic performance when transition from one of the segments to another segment occurs, and
   comparing the transition performance coefficient of different transition paths and outputting a transition path having a higher economic performance than other ones of the transition paths.

### [Clause 13]

The information processing system according to clause 12, where
the forecasting process includes inputting input data to a further learning model,
the input data includes first input data and second input data,
the first input data includes a number of transitioning users transitioned through a certain transition path during a certain period,
the second input data includes a value indicating a quality of the transitioning users in the certain transition path, and
the learning model outputs the transition performance coefficient of the certain transition path when the input data is input.

### [Clause 14]

The information processing system according to any one of clauses 1 to 13, where the one or more processors are operable to further execute a graph outputting process for outputting one or more graphs indicating distribution of users included in each of the segments.

### [Clause 15]

The information processing system according to clause 14, where
the one or more graphs includes representation of a transition history of the users, and
the transition history includes a transition path indicating transition from one of the segments to another one of the segments.

### [Clause 16]

A method for processing information implemented by one or more computers, the method including:
categorizing users into segments; and
inferring, from attributes of the users, one or more transition attributes that are characteristic to a transitioning user who will transition to another segment as time elapses,
where the inferring includes
   predicting whether each of the users will become the transitioning user, and
   calculating importance of each of the attributes in the prediction.

### [Clause 17]

The method according to claim 16, further including:
outputting a target group from at least one of the segments, where the target group includes one or more transitional users each having the one or more transition attributes, and one or more similar users each having one or more attributes similar to the transition attributes;
forecasting a transition performance coefficient indicating economic performance when transition from one of the segments to another segment occurs; and
executing one of the classifying, the inferring, the outputting, and the forecasting with the one or more computers, and then feeding back a result of the execution to one or more remaining ones of the classifying, the inferring, the outputting, and the forecasting.

### [Clause 18]

A method for generating a learning model, where
when users a categorized into segments, a user who transitions to another segment as time elapses is a transitioning user,
user data includes attribute data of the users,
the learning model is configured to receive the user data and output a result of a prediction of whether each of the users will become the transitioning user, and importance of each of the attributes in the prediction,
the method including:
acquiring training data;
training a pre-trained learning model with the training data,
where the training data includes the user data and a ground truth label indicating whether each of the users included in the user data is the transitioning user.

### [Clause 19]

A non-transitory computer-readable medium storing a computer program, which when executed by one or more computers, cause performance of operations including:
categorizing users into segments; and
inferring, from attributes of the users, one or more transition attributes that are characteristic to a transitioning user who will transition to another segment as time elapses,
where the inferring includes
predicting whether each of the users will become the transitioning user, and
calculating importance of each of the attributes in the prediction.

### [Clause 20]

An information processing system, including:
one or more memories that store computer program codes; and
one or more processors operable to execute processes based on the computer program codes, where
the one or more processors are operable to execute
   an acquiring process for acquiring user data including data of the users, the user data including classification data indicating to which of the segments each of the users belongs during each of multiple periods, and attribute data indicating the attributes of the users,
   an inferring process for inferring, from the attributes, one or more transition attributes that are characteristic to a transitioning user who will transition to another segment as time elapses, and
   an extracting process for extracting one or more similar users from at least one of the segments, the one or more similar users each having one or more attributes similar to the one or more transition attributes.

### [Clause 21]

A method for processing information implemented by one or more computers, the method including:
acquiring user data including data of users, the user data including classification data indicating to which of the segments each of the users belongs during each of multiple periods, and attribute data indicating the attributes of the users,
inferring, from the attributes, one or more transition attributes that are characteristic to a transitioning user who will transition to another segment as time elapses, and
extracting one or more similar users from at least one of the segments, the one or more similar users each having one or more attributes similar to the one or more transition attributes.

### [Clause 22]

A method for generating a learning model, the learning model is configured to output a transition performance coefficient of a transition path when input data is input, the method including:
acquiring training data; and
training a pre-trained learning model with the training data, where
the training data and the input data include first input data and second input data,
the first input data includes a number of transitioning users transitioned through the transition path during a certain period, and
the second input data includes a value indicating a quality of the transitioning users in the transition path.

### [Clause 23]

A non-transitory computer-readable medium storing a computer program, which when executed by one or more computers, causes performance of operations including:
acquiring user data including data of users, the user data including classification data indicating to which of the segments each of the users belongs during each of multiple periods, and attribute data indicating the attributes of the users,
inferring, from the attributes, one or more transition attributes that are characteristic to a transitioning user who will transition to another segment as time elapses, and
extracting one or more similar users from at least one of the segments, the one or more similar users each having one or more attributes similar to the one or more transition attributes.

### [Clause 24]

An information processing system, including:
one or more memories that store computer program codes; and
one or more processors operable to execute processes based on the computer program codes, where
the one or more processors are operable to execute
   an acquiring process for acquiring strategic data related to one or more marketing strategies, the strategic data including prediction data related to which one of multiple segments a user belonging to one of the segments will transition to after the one or more marketing strategies are performed, and
   a forecasting process for forecasting, from the strategic data, an economic performance when user transition occurs, the forecasting process includes
   calculating a transition performance coefficient that indicates the economic performance when transition from one of the segments to another segment occurs, and
   comparing the transition performance coefficient of different transition paths and outputting a transition path having a higher economic performance than other ones of the transition paths.

### [Clause 25]

A method for processing information implemented by one or more computers, the method including:
acquiring strategic data related to one or more marketing strategies, the strategic data including prediction data related to which one of multiple segments a user belonging to one of the segments will transition to after the one or more marketing strategies are performed, and
forecasting, from the strategic data, an economic performance when user transition occurs,
where the forecasting includes
   calculating a transition performance coefficient that indicates the economic performance when transition from one of the segments to another segment occurs, and
comparing the transition performance coefficient of different transition paths and outputting a transition path having a higher economic performance than other ones of the transition paths.

### [Clause 26]

A non-transitory computer-readable medium storing a computer program, which when executed by one or more computers, cause performance of operations including:
acquiring strategic data related to one or more marketing strategies, the strategic data including prediction data related to which one of multiple segments a user belonging to one of the segments will transition to after the one or more marketing strategies are performed, and
forecasting, from the strategic data, an economic performance when user transition occurs,
where the forecasting includes
   calculating a transition performance coefficient that indicates the economic performance when transition from one of the segments to another segment occurs, and
   comparing the transition performance coefficient of different transition paths and outputting a transition path having a higher economic performance than other ones of the transition paths.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An information processing system, comprising:
one or more memories that store computer program codes; and
one or more processors operable to execute processes based on the computer program codes, wherein
the one or more processors are operable to execute
a categorizing process for categorizing users into segments, and
an inferring process for inferring, from attributes of the users, one or more transition attributes that are characteristic to a transitioning user who will transition to another segment as time elapses,
the inferring process includes an inputting process for inputting user data including the attributes of the users to a learning model,
the learning model outputs a calculation result when the user data is input, and
the calculation result includes a result of a prediction of whether each of the users will become the transitioning user, and importance of each of the attributes in the prediction.

2. The information processing system according to claim 1, wherein the inferring process further includes extracting, from at least one of the segments, a transitional user having the one or more transition attributes.

3. The information processing system according to claim 1, wherein
the users use one or more services provided by a business entity,
the one or more services include one or more of a point-program service, a credit card service, an electronic payment service, a commercial transaction service, a travel business service, a communication service, a banking service, a securities trading service, and an insurance service, and
the user data includes a usage history of the one or more services.

4. The information processing system according to claim 3, wherein
the categorizing process includes categorizing the users based on segmenting indicators,
the segmenting indicators include a frequency indicator related to usage frequency of each of the services, and a quantitative indicator related to an expenditure on each of the services, and
each of the segmenting indicators includes boundary values set so that adjacent ones of the segments are seamlessly continuous.

5. The information processing system according to claim 4, wherein the segmenting indicators include indicators related to different services.

6. The information processing system according to claim 1, wherein the segments include at least one of a segment of new users having no usage history of a service or a segment of dormant users who have not used a service over a certain period.

7. The information processing system according to claim 1, wherein the importance of each of the attributes in the prediction is calculated as a SHapley Additive explanations (SHAP) value.

8. The information processing system according to claim 1, wherein the one or more processors are operable to further execute
an acquiring process for acquiring user data including data of the users, the user data including classification data indicating to which of the segments each of the users belongs during each of multiple periods, and attribute data indicating the attributes of the users,
an inferring process for inferring, from the attributes, one or more transition attributes that are characteristic to the transitioning user who will transition to another segment as time elapses, and
an extracting process for extracting one or more similar users from at least one of the segments, the one or more similar users each have one or more attributes similar to the one of more transition attributes.

9. The information processing system according to claim 8, wherein
the extracting process further includes extracting one or more transitional users from at least one of the segments, and
the one or more similar users are extracted from users remaining in the at least one of the segments from which the one or more transitional users are extracted.

10. The information processing system according to claim 9, wherein
the one or more processors are operable to further execute a target outputting process for outputting a target group, and
the target group includes the one or more transitional users and the one or more similar users.

11. The information processing system according to claim 10, wherein
the extracting process includes a converting process for converting attributes of the one or more transitional users into vector representations, and
the extracting process extracts the one or more similar users based on similarity of the vector representations.

12. The information processing system according to claim 1, wherein
the one or more processors are operable to further execute a forecasting process for forecasting an economic performance when user transition occurs,
the forecasting process includes
calculating a transition performance coefficient that indicates the economic performance when transition from one of the segments to another segment occurs, and
comparing the transition performance coefficient of different transition paths and outputting a transition path having a higher economic performance than other ones of the transition paths.

13. The information processing system according to claim 12, wherein
the forecasting process includes inputting input data to a further learning model,
the input data includes first input data and second input data,
the first input data includes a number of transitioning users transitioned through a certain transition path during a certain period,
the second input data includes a value indicating a quality of the transitioning users in the certain transition path, and
the learning model outputs the transition performance coefficient of the certain transition path when the input data is input.

14. The information processing system according to claim 1, wherein the one or more processors are operable to further execute a graph outputting process for outputting one or more graphs indicating distribution of users included in each of the segments.

15. The information processing system according to claim 14, wherein
the one or more graphs includes representation of a transition history of the users, and
the transition history includes a transition path indicating transition from one of the segments to another one of the segments.

16. A method for processing information implemented by one or more computers, the method comprising:
categorizing users into segments; and
inferring, from attributes of the users, one or more transition attributes that are characteristic to a transitioning user who will transition to another segment as time elapses,
wherein the inferring includes
predicting whether each of the users will become the transitioning user, and
calculating importance of each of the attributes in the prediction.

17. The method according to claim 16, further comprising:
outputting a target group from at least one of the segments, wherein the target group includes one or more transitional users each having the one or more transition attributes, and one or more similar users each having one or more attributes similar to the transition attributes;
forecasting a transition performance coefficient indicating economic performance when transition from one of the segments to another segment occurs; and
executing one of the classifying, the inferring, the outputting, and the forecasting with the one or more computers, and then feeding back a result of the execution to one or more remaining ones of the classifying, the inferring, the outputting, and the forecasting.

18. A non-transitory computer-readable medium storing a computer program, which when executed by one or more computers, causes performance of operations comprising:
categorizing users into segments; and
inferring, from attributes of the users, one or more transition attributes that are characteristic to a transitioning user who will transition to another segment as time elapses,
wherein the inferring includes
predicting whether each of the users will become the transitioning user, and
calculating importance of each of the attributes in the prediction.
